(19) United States
(12) Patent Application Publication
(10) Pub. No.: US 2006/0012753 A1
(43) Pub. Date: Jan. 19, 2006

(54) Stereoscopic imaging

(76) Inventors: Robert A. Gandara, Corvallis, OR (US); Bjorn Warloe, Corvallis, OR (US); Sarah Elizabeth Hayes, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/890,539

(22) Filed: Jul. 13, 2004

(51) Int. Cl. G03B 21/00

(52) U.S. Cl. 353/7

(57) ABSTRACT

A stereoscopic imaging method includes intercepting a light flux projecting an image frame having first and second image cells. The light flux is split so that a first portion of the light flux projects the first image cell along a first light path and a second portion of the light flux projects the second image cell along a second light path. The first and second light paths are selected so that the first and second portions of the light flux can cast superimposed images on a target.

### BACKGROUND

The presentation of stereoscopic imagery—three dimensional still pictures and motion video—has been achieved through the use of dual projector systems, single projection systems with the aid of shutter glasses, an other relatively complicated systems. Such systems are typically out of reach of the average consumer. Often, they are expensive and difficult to set up, operate, and maintain. Conventional two dimensional video cameras and projectors, however, are within the reach of many consumers. Unfortunately, these conventional devices do not enable consumers to record and then display stereoscopic imagery.

### DESCRIPTION OF THE DRAWINGS

FIG. 1 depicts an exemplary stereo image according to an embodiment of the present invention.

FIG. 2 illustrates an exemplary stereoscopic adapter coupled to a projector according to an embodiment of the present invention.

FIG. 3 illustrates an exemplary mirror pair placement according to an embodiment of the present invention.

FIG. 4 is perspective view of the exemplary stereoscopic adapter and the projector of FIG. 2 according to an embodiment of the present invention.

FIG. 5 illustrates a first light path through the exemplary stereoscopic adapter and projector of FIG. 2 projecting a right perspective of an image on a target according to an embodiment of the present invention.

FIG. 6 illustrates a second light path through the exemplary stereoscopic adapter and projector of FIG. 2 projecting a left perspective of an image on a target according to an embodiment of the present invention.

FIG. 7 simultaneously illustrates a first and a second light path through the exemplary stereoscopic adapter and projector of FIG. 2 superimposing the left and right image perspectives on a target according to an embodiment of the present invention.

FIG. 8 illustrates an exemplary pair of viewing glasses according to an embodiment of the present invention.

FIG. 9 illustrates the exemplary stereoscopic adapter coupled to an image capture device according to an embodiment of the present invention

### DETAILED DESCRIPTION OF THE INVENTION

INTRODUCTION: Audiences enjoy viewing three dimensional images. Unfortunately systems for capturing and projecting three dimensional images have been too costly for the average consumer. Embodiments of the present invention provide an adapter that can be coupled to an image capture device such as a digital camera to capture stereo images. The stereo images may be still frame or motion video. The adapter can then be coupled to a projector allowing the captured stereo images to be projected on a screen.

The following description is broken into sections. The first section describes an exemplary stereo image. The second section describes the components of an exemplary stereoscopic adapter, and the third section describes the operation of the exemplary adapter.

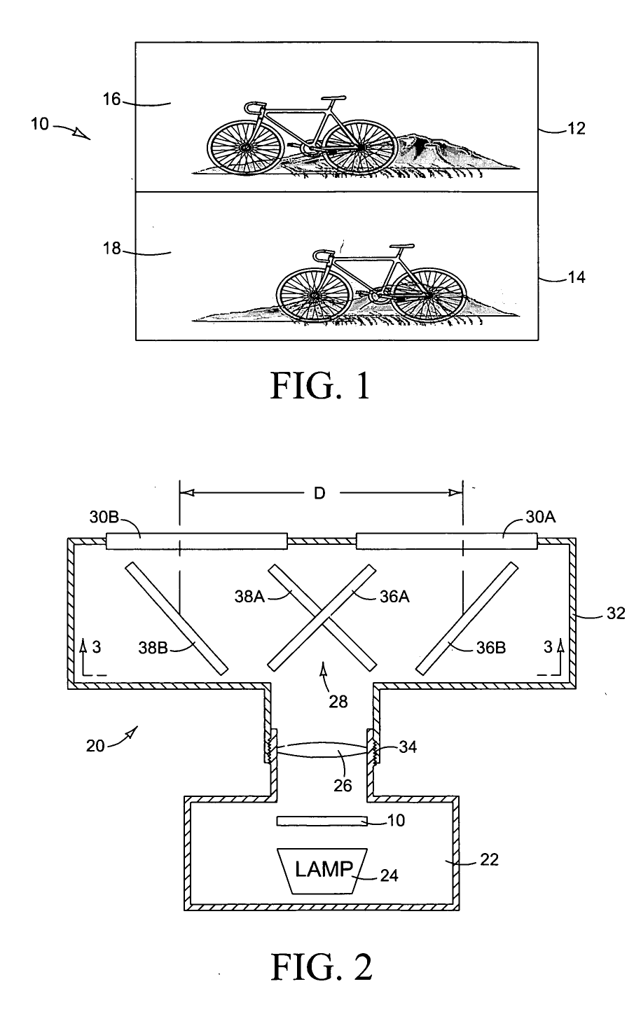

STEREO IMAGE: FIG. 1 illustrates an exemplary stereo image 10. Image 10 can be a physical image such as a photo or slide or it might be a digital image capable of being displayed on a monitor or projected on a screen. Image 10 has two cells, 12 and 14. Cell 12 contains a right perspective image 16 and cell 14 contains a left perspective image 18. Alternatively, cell 12 could contain left perspective image 18, and cell 14 could contain right perspective image 16.

Right and left perspective images 16 and 18 are two representations of an object as seen from two different points not on a straight line with the object. For example, right perspective image 16 may represent the object as seen by an individual's right eye, and left perspective image 18 may represent the object as seen by the individual's left eye.

Cells 12 and 14 are in a top and bottom relative orientation meaning that when positioned to be viewed, cell 12 is on top of cell 14. In the example shown, image 10 has an approximate four to three aspect ratio meaning it has a viewing width of four units and a viewing height of three units. This aspect ratio matches the aspect ration of many CCD (Charge Coupled Device) arrays in digital cameras. The top and bottom orientation of cells 12 and 14 allows each cell 12 and 14 to have an aspect ratio of approximately 4 to 1.5—a ratio more suitable for “wide screen” viewing. It is noted that cells 12 and 14 may instead be a side-by side relative orientation. When positioned to be viewed, cell 12 would be beside cell 14 rather than on top.

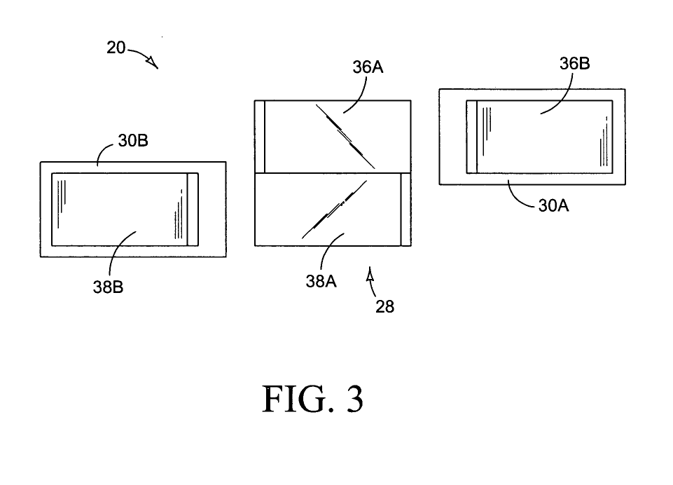

COMPONENTS: FIGS. 2-4 illustrate an exemplary stereoscopic adapter 20 for use in capturing and projecting stereo images such as stereo image 10 of FIG. 1. Referring first to FIG. 2, adapter 20 is coupled to projector 22. Projector 22 represents generally any device capable of projecting a selected image (such as image 10) onto a target. In the simplified example of FIG. 2, projector 22 is a slide projector and includes lamp 24 and lens 26. Here image 10 is on a slide. Lamp 24 directs a light flux through image 10. Lens 26 is then responsible for focusing the flux to cast an image 10 on a screen or other target. It is noted that lens 26 can represent one or more lenses. Alternatively, image 10 may be a digital image and projector 22 may be a digital projector.

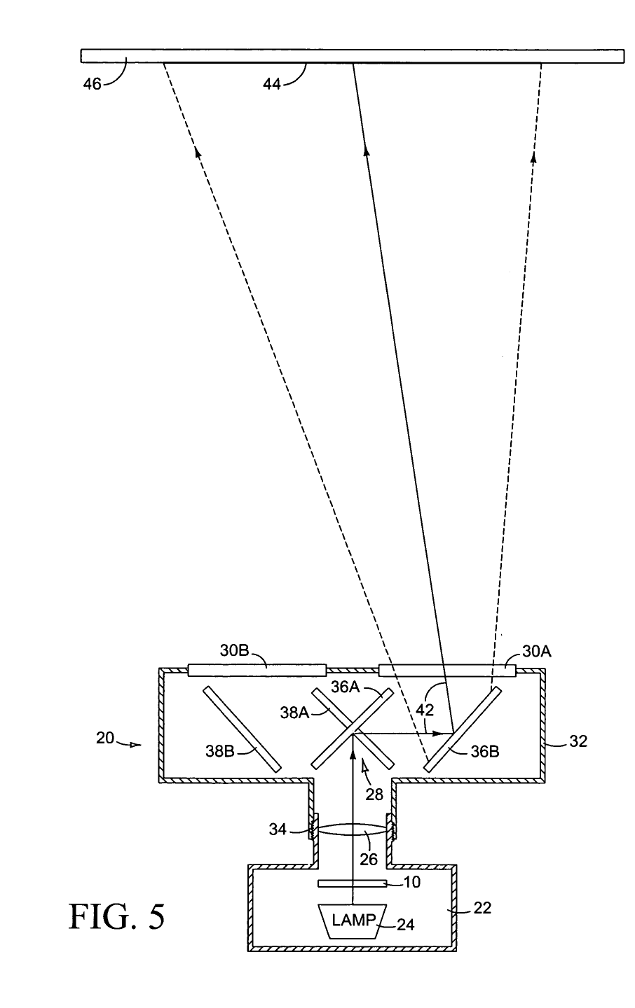

Adapter 20 includes splitter 28, filters 30A and 30B, and housing 32. Splitter 28 represents a component capable of diverting a first portion of a light flux from projector 22 along a first light path and diverting a second portion of the light flux from the projector along a second light path. The first and second light paths are selected so that the first and second portions of the light flux cast superimposed images. Examples of the first and second light paths are described below with reference to FIGS. 5-7. Referring back to FIG. 1 as an example, the first portion of image 10 may include the contents of cell 12 and the second portion may include the contents of cell 14. Splitter 28 is configured to cause the contents of cells 12 and 14 to be superimposed over one another when projected on a screen or other target.

Filter 30A represents generally any component capable of filtering light flux diverted along the first light path by splitter 28. Filter 30B represents generally any component capable of filtering light flux diverted along the second light path by splitter 28. For example, filters 30A and 30B may be polarizing filters having opposing linear or circular polarizing characteristics. Alternatively, filters 30A and 30B may be color filters—one red and the other blue for example. In this way each of the images superimposed on a screen by splitter 28 is filtered differently than the other.

Housing 32 represents generally any structure capable of supporting and holding splitter 28 and filters 30A and 30B stationary relative to one another. Housing also includes coupler 34 which represents generally any structure capable of coupling housing 32 to projector 22. As shown, coupler 34 is configured with threads to allow a user to screw adapter 20 onto projector 22.

In the example shown, splitter 28 includes mirror pairs 36A, 36B and 38A, 38B. Mirrors 36A and 36B are positioned in housing 32 to define the first light path for diverting the contents of first cell 12 of image 10 (FIG. 1). Mirrors 38A and 38B are positioned in housing 32 to define the second light path for diverting the contents of second cell 14 of image 10 (FIG. 1).

Referring now to FIGS. 1, 2 and 3, mirrors 36A and 38A are in a relative top and bottom orientation and positioned to intercept from projector 22 a light flux projecting image 10. Mirror 36A is positioned to intercept a first portion of the light flux projecting the contents of first cell 12 of image 10, and mirror 38A is positioned to intercept a second portion of the light flux projecting the contents of second cell 14 of image 10. Mirror 36A is positioned and aimed to reflect the first portion of the light flux toward mirror 36B. Similarly, mirror 38A is positioned and aimed to reflect the second portion of the light flux toward mirror 38B. Mirrors 36B and 38B are positioned and aimed to reflect the first and second portions of the light flux toward a common target. More particularly, mirrors 36B and 38B are aimed to allow the first and second portions of the light flux to cast superimposed images on that target. Furthermore, the center points of mirrors 36B and 38B are spaced apart a distance (D). Distance (D), for example may approximate the average distance between the eyes of an intended audience member.

It is noted that mirrors 36A and 36B may instead be in a side-by-side relative orientation and positioned to intercept from projector 22 a light flux projecting image cells that are also in side-by-side relative orientation. Mirrors 36B and 38B would then each be positioned and aimed to reflect the light flux to cast superimposed images on a target.

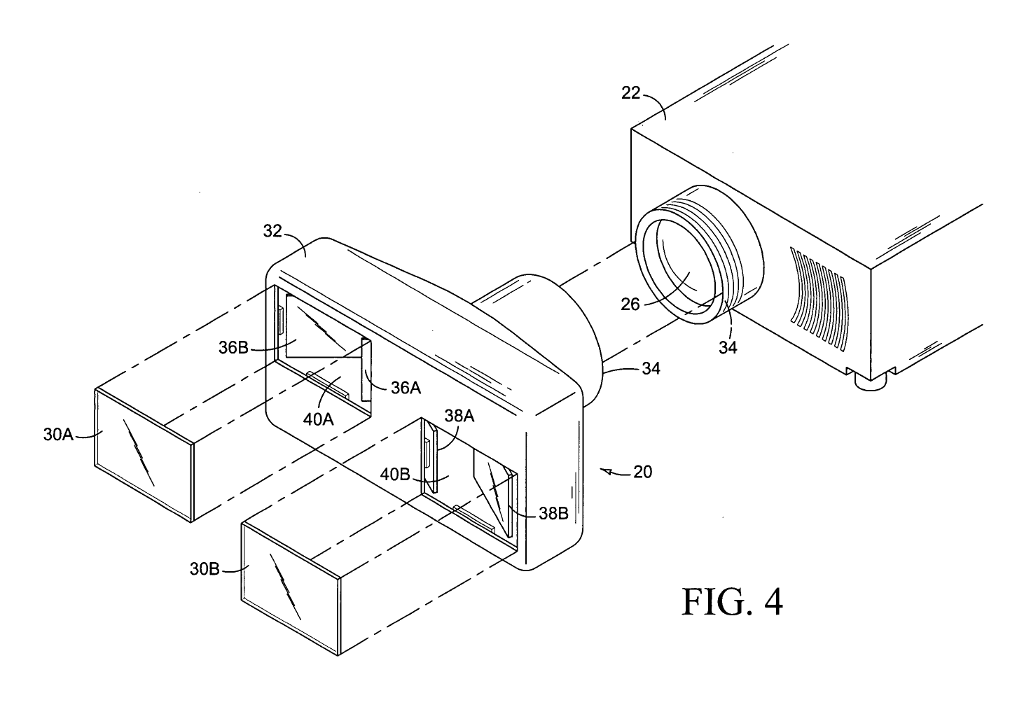

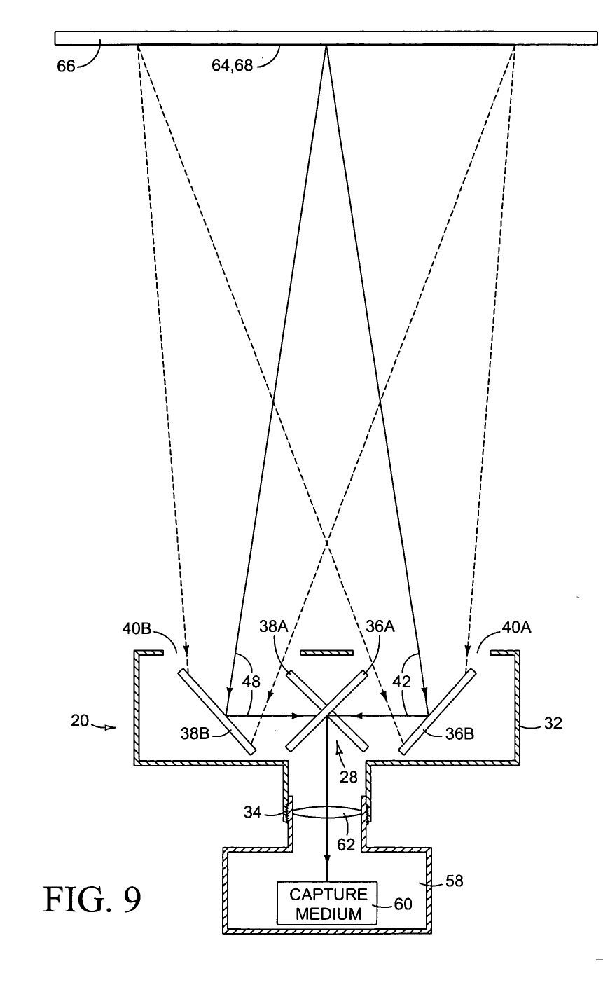

FIG. 4 provides a perspective view of adapter 20 and projector 22. As shown, filters 30A and 30B are removable from housing 32 to reveal apertures 40A and 40B. With filters 30A and 30B removed, adapter 20 can be coupled to an image capture device such as a digital camera for use in capturing stereo images such as stereo image 10 of FIG. 1. An example of adapter 20 coupled to an image capture device is discussed below with reference to FIG. 9.

OPERATION: The operation of exemplary embodiments will now be described with reference to FIGS. 5-9. Starting with FIG. 5, projector 22 casts a light flux projecting image 10. Mirror pair 36A, 36B are positioned to intercept a first portion of the light flux projecting the contents of first cell 12 of image 10 (FIG. 1) diverting the first portion of the light flux along light path 42 defined by mirror pair 36A, 36B. Light path 42 passes through filter 30A filtering the first portion of the light flux. Ultimately, mirror pair 36A, 36B causes the filtered first portion of the light flux to cast projected image 44 on target screen 46.

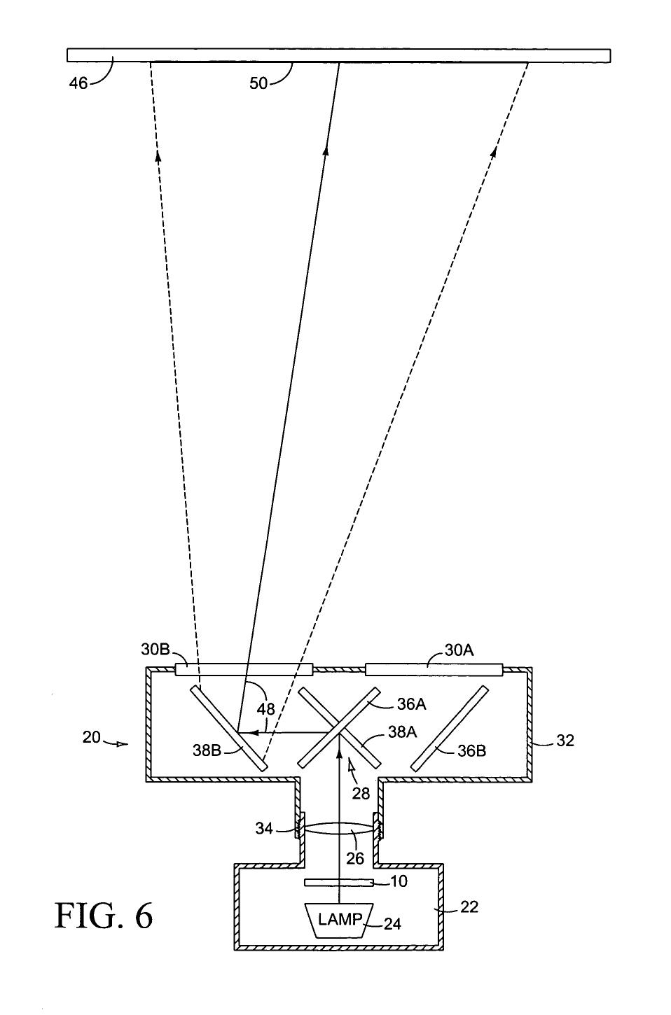

Moving to FIG. 6, mirror pair 38A, 38B are positioned to intercept a second portion of the light flux projecting the contents of second cell 14 of image 10 (FIG. 1), diverting the second portion of the light flux along light path 48 defined by mirror pair 38A, 38B. Light path 48 passes through filter 30B filtering the second portion of the light flux. Ultimately, mirror pair 38A, 38B causes the filtered second portion of the light flux to cast projected image 50 on target screen 46.

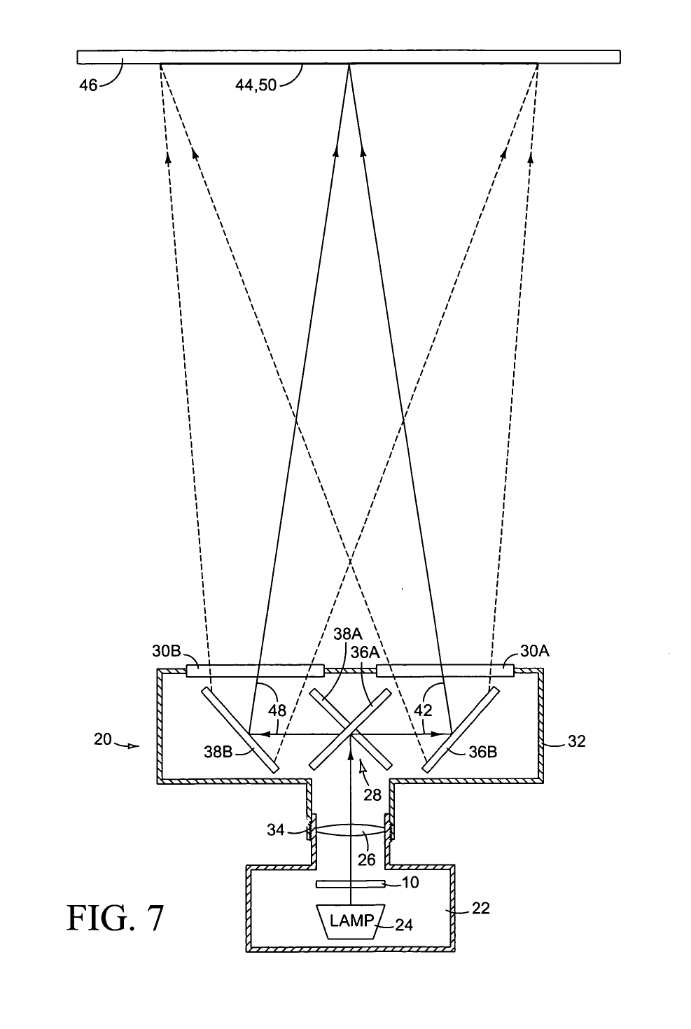

FIG. 7 is a composite of FIGS. 5 and 6. Mirror pairs 36A, 36B, and 38A, 38B have intercepted first and second portions of the light flux projecting image 10. Mirror pairs 36A, 36B divert the first portion along light path 42. Mirror pairs 38A, 38B divert the second portion of the light flux along light path 48. Mirror pairs 36A, 36B, and 38A, 38B are positioned and aimed to combine the filtered first and second portions of the light flux so that projected images 44 and 50 are superimposed over one another on target screen 46. It is noted that where filters 30A and 30B are polarizing filters, screen 46 is selected so that it preserves the polarization of light projected upon it.

As noted above, filters 30A and 30B filter the first and second portions of the light flux in differing manners. For example, filter 30A might provide linear or circular polarization in a given direction. Filter 30B might then provide linear or circular polarization in an opposing direction.

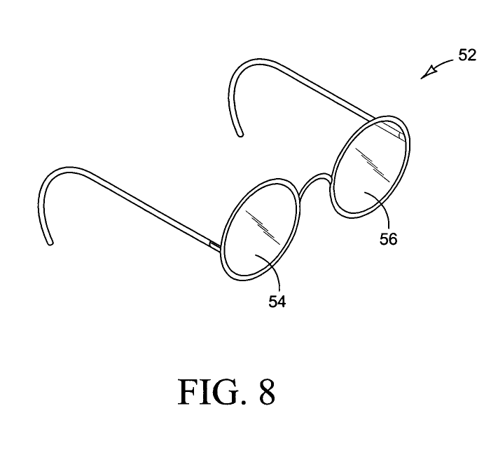

To enjoy a three dimensional presentation provided by the projection of superimposed images 44 and 50 an audience member can benefit from the aid of a filtering viewer. FIG. 8 illustrates an exemplary viewing filter in the form of viewing glasses 52. Glasses 52 include viewing filters 54 and 56. Viewing filter 54 is configured to compliment filter 30A (FIG. 7) meaning that light flux projected through filter 30A can be viewed through viewing filter 54. Viewing filter 54 is configured to oppose filter 30B (FIG. 7) meaning that light flux projected through filter 30B is blocked by viewing filter 54. Similarly, viewing filter 56 is configured to compliment filter 30B and to oppose filter 30A.

Referring to FIGS. 7 and 8 together, an audience member donning viewing glasses 52 is able to see projected image 44 (a right perspective image) with her right eye through viewing filter 54 and see projected image 50 (a left perspective image) with her left eye through viewing filter 56. Viewing filter 54 blocks projected image 50, and viewing filter 56 blocks projected image 44 allowing the audience member to enjoy a three dimensional presentation.

Moving to FIG. 9, adapter 20 is coupled to image capture device 58. Filters 30A and 30B (FIGS. 4-7) have been removed, revealing apertures 40A and 40B. Image capture device 58 represents generally any device capable of recording a still image or motion video. For example, image capture device 58 may be a conventional film camera, a digital camera, a video camera, or a digital video camera. Among other components not shown, image capture device 58 includes capture medium 60 and lens 62. Capture medium 60 represents generally any component on which an image can be recorded or otherwise captured. Capture medium 60, for example, may be film or a CCD (charge coupled device) array. Lens 62 may include one or more lenses and is responsible for focusing an incoming light flux on capture medium 60.

As described above with reference to FIG. 5-7, splitter 28 includes mirror pair 36A, 36B which defines first light path 42 and mirror pair 38A, 38B which defines second light path 48. Mirror pair 36A, 36B collects and diverts a light flux casting right perspective 64 on target 66 along first light path 42. Mirror pair 38A, 38B collects and directs a light flux casting left perspective 68 on target 66 along second light path 48. Mirrors 36A and 38A are positioned and aimed in housing 32 so that they allow lens 62 to focus the light flux casting the left and right perspectives on capture medium. More particularly mirrors 36A and 38A may be aimed to allow lens 62 to focus the light flux casting the left and right perspectives on capture medium in a relative top and bottom orientation to record a stereo image such as image 10 seen in FIG. 1.

CONCLUSION: As described above, embodiments of the present invention provide an adapter for allowing a user to record stereoscopic imagery in the form of still pictures or motion video using a readily available image capture device. The user can then couple the same adapter to a projector to enjoy a three dimensional viewing experience. Although, embodiments of the present invention have been shown and described with reference to the foregoing exemplary implementations, it is to be understood that other forms, details, and embodiments may be made without departing from the spirit and scope of the invention which is defined in the following claims.

What is claimed is:

1. A stereoscopic imaging method, comprising:
intercepting a light flux projecting an image frame having first and second image cells;
splitting the light flux so that a first portion of the light flux projects the first image cell along a first light path and a second portion of the light flux projects the second image cell along a second light path; and
wherein the first and second light paths are selected so that the first and second portions of the light flux can cast superimposed images on a target.

2. The method of claim 1, further comprising filtering the first portion of the light flux and filtering the second portion of the light flux.

3. The method of claim 2, wherein:
filtering the first portion of the light flux comprises polarizing the first portion of the light flux in a first direction; and
filtering the second portion of the light flux comprises polarizing the second portion of the light flux in a second direction, the second direction being generally opposite the first direction.

4. The method of claim 3, wherein the first and second directions are linear directions.

5. The method of claim 3, wherein the first and second directions are circular directions.

6. The method of claim 2, wherein:
filtering the first portion of the light flux comprises color filtering the first portion of the light flux in a first color; and
filtering the second portion of the light flux comprises color filtering the second portion of the light flux in a second color.

7. The method of claim 1, wherein intercepting comprises intercepting a light flux projecting an image frame having first and second image cells in a top and bottom relative orientation.

8. The method of claim 1, wherein intercepting comprises intercepting a light flux projecting an image frame having first and second image cells each having a viewable width and a viewable height, and wherein the viewable width of each image cell is greater than the viewable height.

9. The method of claim 1, wherein intercepting comprises intercepting a light flux projecting an image frame having first and second image cells in a side-by-side relative orientation.

10. The method of claim 1, wherein splitting comprises a first mirror pair reflecting the first portion of the light flux along the first light path and a second mirror pair reflecting the second portion of the light flux along the second light path.

11. The method of claim 10, wherein the first mirror pair reflecting and the second mirror pair reflecting comprises the first and second mirror pairs diverging the first and second portions of the light flux apart from one another by a selected distance and then converging the first and second portions of the light flux to cast superimposed images on the target.

12. The method of claim 11, wherein the selected distance generally corresponds to a distance between an audience member's eyes.

13. A stereo imaging method, comprising:
collecting a first perspective of a target image;
collecting a second perspective image of the target image; and
diverting the first and second perspectives so that the first and second perspectives of the target image can be captured in a relative top and bottom orientation.

14. The method of claim 13, further comprising capturing the first and second perspectives of the target image to form an image frame having corresponding first and second cells in a relative top and bottom orientation.

15. The method of claim 13, wherein diverting comprises:
a first mirror pair diverting the first perspective of the target image along a first light path;
a second mirror pair diverting the second perspective of the target image along a second light path; and
wherein the first and second light paths are selected so that the first and second perspectives of the target image can be captured in the relative top and bottom orientation.

16. A stereoscopic imaging system, comprising:
a means for intercepting a light flux projecting an image frame having first and second image cells;
a means for splitting the light flux so that a first portion of the light flux projects the first image cell along a first light path and a second portion of the light flux projects the second image cell along a second light path; and
wherein the first and second light paths are selected so that the first and second portions of the light flux can cast superimposed images on a target.

17. The system of claim 16, further comprising a means for filtering the first portion of the light flux and a means for filtering the second portion of the light flux.

18. The system of claim 17, wherein:
the means for filtering the first portion of the light flux comprises a polarizing filter configured to polarize the first portion of the light flux in a first direction; and
the means for filtering the second portion of the light flux comprises a second polarizing filter configured to polarize the second portion of the light flux in a second direction, the second direction being generally opposite the first direction.

19. The system of claim 18, wherein the first and second directions are linear directions.

20. The system of claim 18, wherein the first and second directions are circular directions.

21. The system of claim 17, wherein:
the means for filtering the first portion of the light flux comprises a first color filter configured to filter the first portion of the light flux in a first color; and
the means for filtering the second portion of the light flux comprises a second color filter configured to filter the second portion of the light flux in a second color.

22. The system of claim 16, wherein the means for intercepting comprises a means for intercepting a light flux projecting an image frame having first and second image cells in a top and bottom relative orientation.

23. The system of claim 16, wherein the means for splitting comprises a first mirror pair configured to reflect the first portion of the light flux along the first light path and a second mirror pair configured to reflect the second portion of the light flux along the second light path.

24. The system of claim 23, wherein the first mirror pair and the second mirror pair are configured to diverge the first and second portions of the light flux apart from one another by a selected distance and to then converge the first and second portions of the light flux to cast superimposed images on the target.

25. A stereoscopic imaging system, comprising:
a means for collecting a first perspective of a target image;
a means for collecting a second perspective image of the target image; and
a means for diverting the first and second perspectives so that the first and second perspectives of the target image can be captured in a relative top and bottom orientation.

26. The system of claim 25, further comprising a means for capturing the first and second perspectives of the target image to form an image frame having corresponding first and second cells in a relative top and bottom orientation.

27. The system of claim 25, wherein the means for diverting comprises:
a first mirror pair configured to divert the first perspective of the target image along a first light path;
a second mirror pair configured to divert the second perspective of the target image along a second light path; and
wherein the first and second light paths are selected so that the first and second perspectives of the target image can be captured in the relative top and bottom orientation.

28. A stereoscopic adapter, comprising:
a housing;
a coupler configured to couple the housing to a projector;
a splitter positioned within the housing to divert a first portion of a light flux from the projector along a first light path, and to divert a second portion of the light flux from the projector along a second light path, the first and second light paths being positioned so that the first and second portions of the light flux cast superimposed images;
a first filter coupled to the housing and positioned to filter the first portion of the light flux; and
a second filter coupled to the housing and positioned to filter the second portion of the light flux.

29. The adapter of claim 28, wherein the splitter comprises:
a first mirror pair positioned in the housing to divert the first portion of a light flux from the projector along the first light path defined by the first mirror pair;
a second mirror pair positioned in the housing to divert the second portion of the light flux from the projector along a second light path defined by the second mirror pair.

30. The adapter of claim 29, wherein the first mirror pair and the second mirror pair are positioned in the housing to diverge the first and second portions of the light flux apart from one another by a selected distance and to then converge the first and second portions of the light flux to cast superimposed images.

31. The adapter of claim 28, wherein:
the first filter is configured to polarize the first portion of the light flux in a first direction; and
the second filter is configured to polarize the second portion of the light flux in a second direction, the second direction being generally opposite the first direction.

32. The adapter of claim 31, wherein the first and second directions are linear directions.

33. The adapter of claim 31, wherein the first and second directions are circular directions.

34. The adapter of claim 28, wherein:
the first filter is configured to filter the first portion of the light flux in a first color; and
the second filter is configured to filter the second portion of the light flux in a second color.

35. The adapter of claim 28, wherein the light flux projects an image frame having first and second image cells in a top and bottom relative orientation and wherein the splitter is positioned in the housing to divert the first portion of the light flux projecting the first image cell, and to divert the second portion of the light flux projecting the second image cell.

36. The adapter of claim 28, wherein the coupler is also configured to couple the housing to an image capture device and wherein the splitter is positioned within the housing to collect a first perspective of a target image, to collect a second perspective image of the target image, and to divert the first and second perspectives in a relative top and bottom orientation to be captured by the image capture device.

37. The adapter of claim 36, wherein the first and second filters are removably coupled to the housing.

38. The adapter of claim 36, wherein the splitter comprises:
a first mirror pair positioned in the housing to define the first light path; and
a second mirror pair positioned in the housing to define the second light path.

39. A stereoscopic adapter, comprising:
a housing;
a coupler configured to couple the housing to an image capture device;
a splitter positioned within the housing to collect a first perspective of a target image, to collect a second perspective image of the target image, and to divert the first and second perspectives in a relative top and bottom orientation to be captured by the image capture device.

40. The adapter of claim 39, wherein the splitter comprises:
a first mirror pair configured to divert the first perspective of the target image along a first light path;
a second mirror pair configured to divert the second perspective of the target image along a second light path; and
wherein the first and second light paths are defined so that the first and second perspectives of the target image can be captured in the relative top and bottom orientation.
